(19) United States
(12) Patent Application Publication
(10) Pub. No.: US 2024/0296156 A1
(43) Pub. Date: Sep. 5, 2024

(54) INFORMATION PROCESSING DEVICE, CONTROL METHOD, AND STORAGE MEDIUM

(71) Applicant: NEC Corporation, Minato-ku, Tokyo (JP)

(72) Inventors: Genki Kusano, Tokyo (JP); Masafumi Oyamada, Tokyo (JP); Yuyang Dong, Tokyo (JP); Takuma Nozawa, Tokyo (JP)

(73) Assignee: NEC Corporation, Minato-ku, Tokyo (JP)

(21) Appl. No.: 18/272,616

(22) PCT Filed: Jan. 25, 2021
(86) PCT No.: PCT/JP2021/002432

§ 371 Date: Jul. 17, 2023

(51) Int. Cl. G06F 16/23

(52) U.S. Cl. CPC G06F 16/2365

(57) ABSTRACT

The information processing device 1X mainly include a feature acquisition means 15X, a universal feature conversion means 16X, and a related user identification means 18X. The feature acquisition means 15X is configured to acquire first data set specific features, which are user's features specific to a first data set and second data set specific features, which are user's features specific to a second data set. The universal feature conversion means 16X is configured to convert the first data set specific features and the second data set specific features into universal features which are features in a universal feature space for the first data set and the second data set, respectively. The related user identification means 18X is configured to identify a user related to the first data set and the second data set based on the universal features of the first data set and the universal features of the second data set.

### TECHNICAL FIELD

The present disclosure relates to a technical field of an information processing device, a control method, and a storage medium for processing data.

### BACKGROUND ART

An example of a method of identifying related user's data from data regarding a plurality of users is disclosed in Patent Literature 1. Patent Literature 1 discloses a method of receiving evaluation data for a plurality of evaluation targets through a network and associates and stores a first user among a plurality of users with a second user having a similar evaluation tendency to the evaluation data of the first user. Further, Non-Patent Literature 1 discloses a method of performing matrix decomposition by optimization.

### CITATION LIST

### Patent Literature

Patent Literature 1: JP 2020-038727A

### Non-Patent Literature

Non-Patent Literature 1: Li, B.; Yang, Q.; and Xue, X. 2009a. Can movies and books collaborate? cross-domain collaborative filtering for sparsity reduction. In IJCAI, 2052-2057.

### SUMMARY

### Problem to be Solved

From a viewpoint of protecting personal information, there are cases where conventional user linkage methods using personal information such as name and/or Cookie information are not available. On the other hand, in Patent Literature 1, user attributes relating to likes and tastes are manually extracted on a rule basis. However, unfortunately, when the amount of data is large, the manual work becomes enormous and the working cost becomes excessive.

In view of the above-described issue, it is therefore an example object of the present disclosure to provide an information processing device, a control method, and a storage medium capable of suitably identifying a user related among different data sets.

### Means for Solving the Problem

In one mode of the information processing device, there is provided an information processing device including:
a feature acquisition means configured to acquire
   first data set specific features which are user's features specific to a first data set and
   second data set specific features which are user's features specific to a second data set;
a universal feature conversion means configured to convert the first data set specific features and the second data set specific features into universal features which are features in a universal feature space for the first data set and the second data set, respectively; and
a related user identification means configured to identify a user related to the first data set and the second data set based on the universal features of the first data set and the universal features of the second data set.

In one mode of the control device, there is provided a control method executed by a computer, the control method including:
acquiring
   first data set specific features which are user's features specific to a first data set and
   second data set specific features which are user's features specific to a second data set;
converting the first data set specific features and the second data set specific features into universal features which are features in a universal feature space for the first data set and the second data set, respectively; and
identifying a user related to the first data set and the second data set based on the universal features of the first data set and the universal features of the second data set.

In one mode of the storage medium, there is provided a storage medium storing a program executed by a computer, the program causing the computer to:
acquire
   first data set specific features which are user's features specific to a first data set and
   second data set specific features which are user's features specific to a second data set;
convert the first data set specific features and the second data set specific features into universal features which are features in a universal feature space for the first data set and the second data set, respectively; and
identify a user related to the first data set and the second data set based on the universal features of the first data set and the universal features of the second data set.

### Effect

An example advantage according to the present invention is to suitably identify a user related among different data sets.

### BRIEF DESCRIPTION OF THE DRAWINGS

FIG. 1 It illustrates a schematic configuration of a user linkage system according to a first example embodiment.

FIG. 2 It illustrates an example of a hardware configuration of an information processing device.

FIG. 3 It is an example of a functional block diagram of the information processing device according to the first example embodiment.

FIG. 4 It is a diagram showing an overview of the mapping h^{s}.

FIG. 5 It is a diagram showing an overview of the mapping φ^{s} and the mapping φ^{t}.

FIG. 6 It is a diagram showing an outline of the mapping sim and mapping Sync.

FIG. 7A is an example of the data structure of the first data set representing the purchase history in a supermarket.

FIG. 7B is an example of the data structure of the second data set representing the browsing history in the Internet.

FIG. 7C is an example of a table information representing tags associated with each site.

FIG. 8A illustrates an example of the data set specific feature calculated from the first data set shown in FIG. 7A.

FIG. 8B illustrates an example of the data set specific feature calculated from the second data set shown in FIG. 7B and the table information shown in FIG. 7C.

FIG. 9 It is a diagram showing an outline of a process of converting the data set specific features shown in FIG. 8A and the data set specific features shown in FIG. 8B to universal features, respectively.

FIG. 10A indicates the purchase history data of the user to be linked.

FIG. 10B indicates the browsing history data of the users to be linked.

FIG. 11 It is an example of a flowchart showing a procedure of a user linkage process.

FIG. 12 It is a block diagram of an information processing device according to a second example embodiment.

FIG. 13 It is an example of a flowchart in the second example embodiment.

### EXAMPLE EMBODIMENTS

Hereinafter, example embodiments of an information processing device, a control method, and a storage medium will be described with reference to the drawings.

### First Example Embodiment

### (1) Overall Configuration

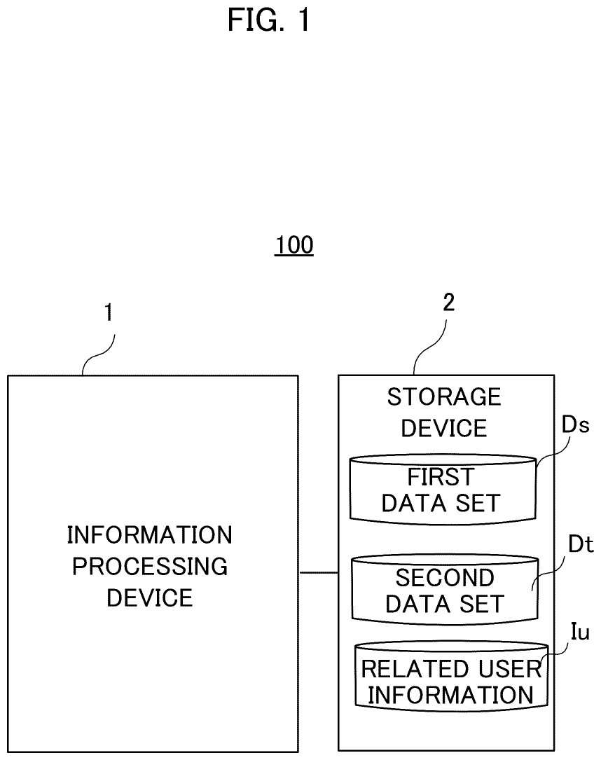

FIG. 1 shows a schematic configuration of a user linkage system 100 according to the first example embodiment. The user linkage system 100 performs the linkage of users (i.e., identification and association of users) related among a plurality of data sets. The user linkage system 100 includes an information processing device 1 and a storage device 2.

The information processing device 1 identifies one or more users (also called the “related users”) related to both of the first data set “Ds” and the second data set “Dt” stored in the storage device 2, and stores the information regarding the identified related users in the storage device 2 as the related user information “Iu”. The information processing device 1 may be configured by a plurality of devices. In this case, the plurality of devices may execute the allocated process using cloud computing technology or the like, and exchange information necessary for the allocated processing with one another.

A storage device 2 is one or more memories for storing various information necessary for processing to be performed by the information processing device 1. The storage device 2 may be an external storage device, such as a hard disk, connected to or embedded in the information processing device 1, or may be a storage medium, such as a flash memory. The storage device 2 may be one or a plurality of server devices that perform data communication with the information processing device 1. The storage device 2 stores the first data set Ds, the second data set Dt, and the related user information Iu. When the storage device 2 is configured by a plurality of devices, the storage device 2 may store the information in a distributed manner.

The first data set Ds and the second data set Dt each is a set of data with respect to each user, and any users are not linked between the data sets. For example, the first data set Ds and the second data set Dt each includes user IDs that uniquely identify users within each data set. Examples of the first data set Ds and the second data set Dt include a database of action histories (e.g., purchase histories, web search histories, etc.,) for respective users, questionnaire results for respective users, comment (sentence) information and image data that are open to the public in the SNS (Social Networking Service). The first data set Ds and the second data set Dt may be data sets generated by different entities (companies, individuals, municipalities, etc.), or may be data sets generated by different departments (e.g., a sale department and a marketing department) in a single entity, respectively.

The first data set Ds and the second data set Dt do not contain common user attributes (i.e., the attributes linking the users between the data sets) that are common to the data sets. The above attributes include demographic attributes such as gender, age, residential area, income, occupation, family composition, and any other personal information. Even in this case, the information processing device 1 suitably identifies the users to be linked between the first data set Ds and the second data set Dt by a method to be described later.

The related user information Iu is information regarding users which are related to both the first data set Ds and the second data set Dt. For example, the related user information Iu is table information which links the user ID of a user, identified as a related user, of the first data set Ds with the user ID of a user, identified as the corresponding related user, of the second data set Dt. The related user information Iu is generated by executing the user linkage process described later by the information processing device 1. The users to be linked as the related users may be not only a single person registered as the different user IDs in the respective data sets but also different persons with similar attributes.

### (2) Hardware Configuration

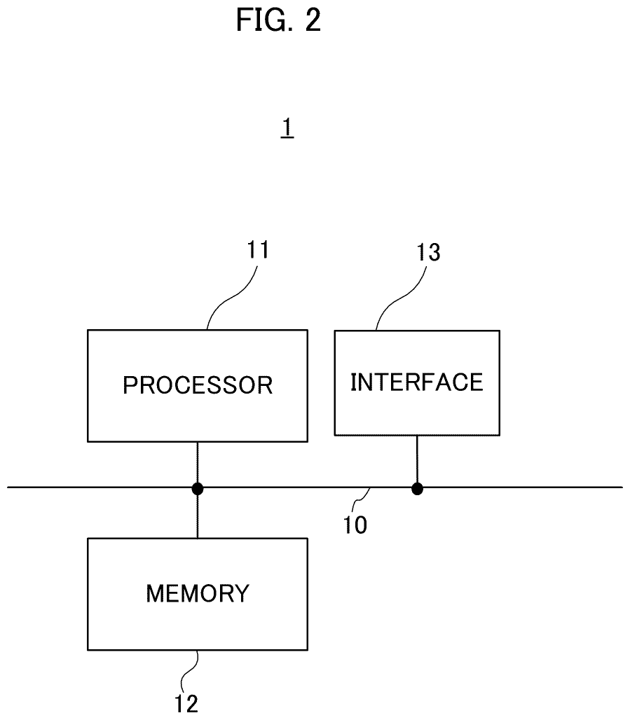

FIG. 2 shows an example of a hardware configuration of the information processing device 1. The information processing device 1 includes a processor 11, a memory 12, and an interface 13 as hardware. The processor 11, the memory 12 and the interface 13 are connected to one another via a data bus 10.

The processor 11 executes a predetermined process by executing a program or the like stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories used as working memories non-volatile memories for storing the information necessary for the processing by the information processing device 1, such as a RAM (Random Access Memory) and a ROM (Read Only Memory). The memory 12 may include an external storage device, such as a hard disk, that is connected or embedded in the information processing device 1, or may include a storage medium, such as a removable flash memory. In the memory 12, a program for the information processing device 1 to execute each process in the present example embodiment is stored. The memory 12 functions as a storage device 2 or a part of the storage device 2, or may store at least one of the first data set Ds, the second data set Dt, or the related user information Iu.

The interface 13 is one or more interfaces for electrically connecting the information processing device 1 to other devices. Examples of these interfaces include a wireless interface, such as network adapters, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may further include an input unit for receiving a user input, an output unit such as a display and a speaker, and the like.

### (3) User Linkage Process

A description will be given of the user linkage process performed by the information processing device 1. Schematically, the information processing device 1 converts features of the users, each specific to the first data set Ds and the second data set Dt, into the features in a common feature space, and performs user linkage based on the degree of the similarity of the converted features. Accordingly, the information processing device 1 suitably executes user linkage among different data sets.

### (3-1) Functional Block

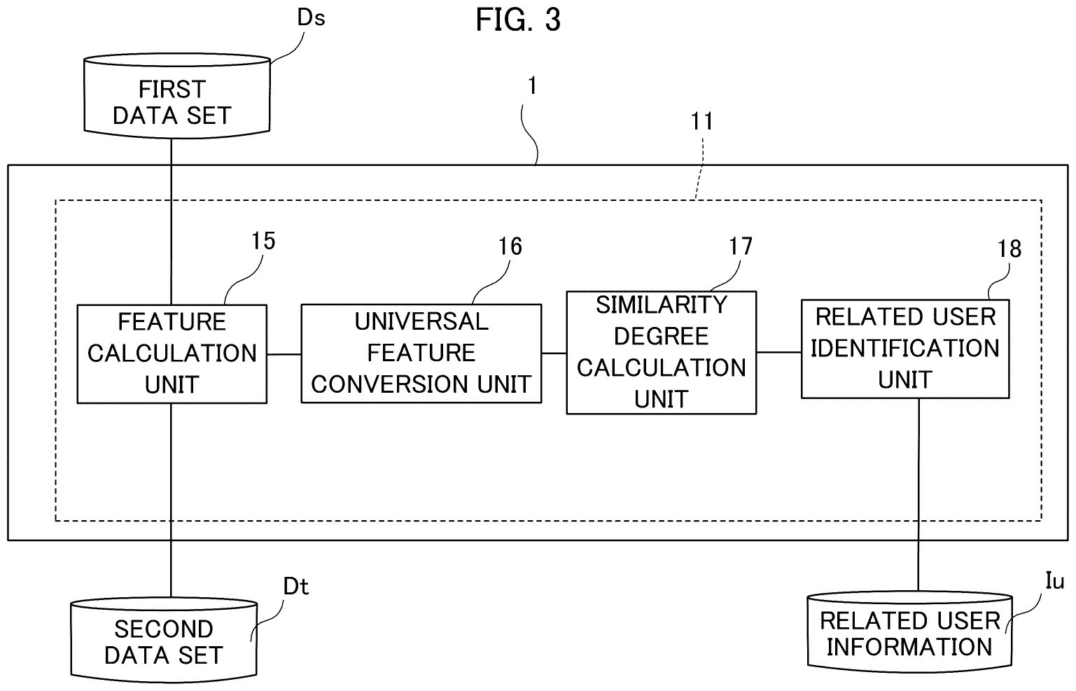

FIG. 3 is an example of a functional block diagram of the information processing device 1 related to the user linkage process according to the first example embodiment. As shown in FIG. 3, the processor 11 of the information processing device 1 functionally includes a feature calculation unit 15, a universal feature conversion unit 16, a similarity degree calculation unit 17, and a related user identification unit 18. In FIG. 3, blocks for exchanging data with each other are connected by solid line, but the combinations of the blocks for exchanging data with each other is not limited to the combinations shown in FIG. 3. The same applies to the drawings of other functional blocks described below.

The feature calculation unit 15 calculates, from each data set, features that are numerical vectors representing users in the each data set. The calculation method of the features is arbitrary, and the specific example will be described later. Each feature calculated by the feature calculation unit 15 is a feature specific to the each data set, and is also referred to as “data set specific feature” hereafter. The feature calculation unit 15 calculates the data set specific features specific to the first data set Ds and the data set specific features specific to the second data set Dt, respectively, and supplies the calculation results to the universal feature conversion unit 16.

The universal feature conversion unit 16 converts the data set specific features specific to the first data set Ds calculated by the feature calculation unit 15 and the data set specific features specific to the second data set Dt into universally-represented features (also referred to as “universal features”) in a common feature space. The conversion process from the data set specific feature to the universal feature by the universal feature conversion unit 16 may be performed according to an arbitrary method, and a specific example of the process executed by the universal feature conversion unit 16 will be described later.

The similarity degree calculation unit 17 calculates the degree of the similarity between the universal feature of the first data set Ds and the universal feature of the second data set Dt outputted by the universal feature conversion unit 16 in all possible combinations between the user of the first data set Ds and the user of the second data set Dt. This method of calculating the degree of similarity is arbitrary, and a specific example will be described later.

The related user identification unit 18 identifies one or more related users based on the degree of similarity between the user of the first data set Ds calculated by the similarity degree calculation unit 17 and the user of the second data set Dt, and generates the related user information Iu based on the identification results. The method of specifying the related user from the similarity described above is arbitrary, and specific examples will be described later.

Here, each component of the feature calculation unit 15, the universal feature conversion unit 16, the similarity degree calculation unit 17, and the related user identification unit 18 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using user programmable integrated circuit such as FPGA (Field-Programmable Gate Array) and microcontrollers. In this case, an integrated circuit may be used to realize a program to function as each of the above components. Further, at least a part of the components may be constituted by an ASSP (Application Specific Standard Produce), an ASIC (Application Specific Integrated Circuit) or a quantum processor (quantum computer control chip). Thus, each of the above-described components may be realized by various hardware. The above explanation is true in other example embodiments described later. Furthermore, each of these components may be implemented by the cooperation of a plurality of computers, for example, using cloud computing technology.

### (3-2) Process by Feature Calculation Unit

A specific method of calculating the data set specific feature by the feature calculation unit 15 will be described. For example, the features calculation unit 15 performs the process of implementing the mapping “h^{s}” shown in the following equation (1) for the first data set Ds.

$$\begin{matrix}[ Formula 1 ] & \\ {h}^{S} : {d}_{i}^{S} ∈ {D}^{S} ↦ {x}_{i}^{S} ∈ {R}^{{M}_{S}} & ( 1 )\end{matrix}$$

Here, “D^{s}” denotes the space of the first data set Ds (i.e., the raw data), and “d^{s}ᵢ” denotes the data related to user i (i∈U^{s}, U^{s} is a set of users registered in the first data set Ds). The “x^{s}ᵢ” denotes the data set specific feature specific to the first data set Ds, which is calculated from the data d^{s}ᵢ, and the “Mₛ” denotes the dimensions of the feature space of the data set specific feature specific to the first data set Ds, respectively. In this instance, “X^{s}”, which is a set of data set specific features specific to the first data set Ds, is expressed by the following equation (2).

$$\begin{matrix}[ Formula 2 ] & \\ {X}^{S} = \{ {x}_{i}^{S} = {h}^{S} ( {d}_{i}^{S} ) \vert i ∈ {U}^{S} \} & ( 2 )\end{matrix}$$

The data set specific features X^{s} specific to the first data set Ds is an example of “the first data set specific features”.

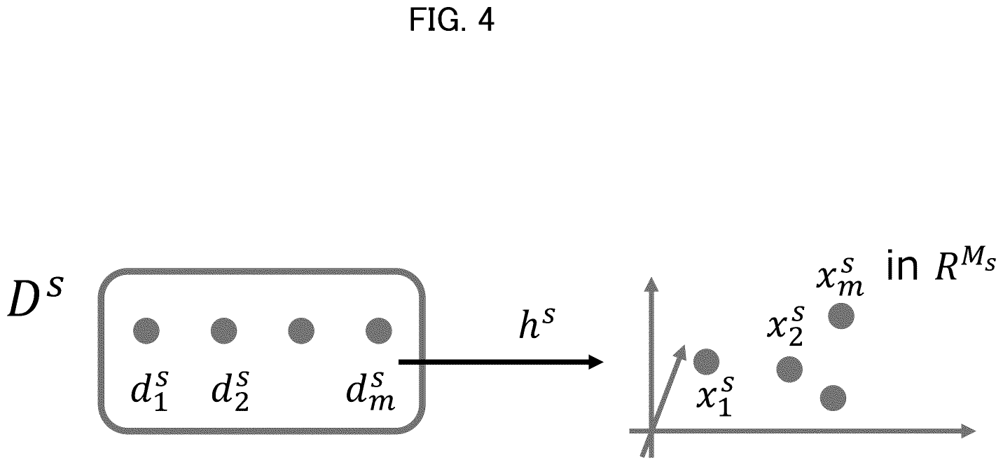

FIG. 4 is a diagram illustrating an overview of the mapping h^{s}. In FIG. 4, the first data set Ds (={d^{s}₁, d^{s}₂, . . . , d^{s}ₘ}), which is the raw data, is converted to the data set specific features (X^{s}={x^{s}₁, x^{s}₂, . . . , x^{s}ₘ}) by the feature calculation unit 15.

Further, the feature calculation unit 15 similarly performs the process of implementing the mapping “h^{t}” shown in the following equation (3) for the second data set Dt.

$$\begin{matrix}[ Formula 3 ] & \\ {h}^{t} : {d}_{i}^{t} ∈ {D}^{t} ↦ {x}_{i}^{t} ∈ {R}^{{M}_{t}} & ( 3 )\end{matrix}$$

Here, “D^{t}” denotes the space of the second data set Dt, and “d^{t}ⱼ” denotes the data related to user j (j∈U^{t}, U^{t} is a set of users registered in the second data set Dt). The “x^{t}ⱼ” denotes the data set specific feature specific to the second data set Dt, which is calculated from the data d^{t}ⱼ, and the “Mₜ” denotes the dimensions of the feature space of the data set specific feature specific to the second data set Dt, respectively. In this instance, “X^{t}”, which is a set of data set specific features specific to the second data set Dt, is expressed by the following equation (4).

$$\begin{matrix}[ Formula 4 ] & \\ {X}^{t} = \{ {x}_{j}^{t} = {h}^{t} ( {d}_{j}^{t} ) \vert j ∈ {U}^{t} \} & ( 4 )\end{matrix}$$

The data set specific features X^{t} specific to the second data set Dt is an example of the “second data set specific features”.

Next, a specific example of a method of calculating the data set specific features will be described.

For example, if the data set to be the target of calculation of the data set specific features is an action history (i.e., a series of items that are taken by the user) of purchasing a product, browsing a site (website), listening to music, and the like, the feature calculation unit 15 calculates the data set specific features by applying BoW (Bag of Words), TF-IDF, Okapi BM25, or the like. In another example, if the data set to be the target of calculation of the data set specific features is a set of sentences (comments), the feature calculation unit 15 calculates the data set specific features by applying Doc2Vec, SCDV (Sparse Composite Document Vectors), BoW, TF-IDF, Okapi BM25, or the like.

In addition, if the data set to be the target of calculation of the data set specific features includes an image, the feature calculation unit 15 may acquire, as a data set specific feature, the feature extraction result obtained by inputting the above-described image to the feature extraction engine that has already trained by deep learning or the like. If the uploaded data (sentences and images) in a SNS are used as the data set, the feature calculation unit 15 may calculates the data set specific features by applying the above-described BoW, TF-IDF, Okapi BM25 or the like to the tags attached together with the uploaded data. Thus, the feature calculation unit 15 may calculate the data set specific features not only using items (dataset) itself but also using the attributes associated with the items. This specific example will be described in the section “(4) Specific Examples”

If the data set is numerical data regarding a multiple-choice questionnaire result and the like, the feature calculation unit 15 may use the numerical data as a data set specific features. In this case, the feature calculation unit 15 acquires the data set specific features in which the identity mapping is performed on the data set.

### (3-3) Process by Universal Feature Conversion Unit

Next, a description will be given of the process of the universal feature conversion unit 16 that converts the respective data set specific features specific to the first data set Ds and the second data set Dt into universal features. The universal features conversion unit 16 performs the process of implementing the mapping “φ^{s}” shown in the following equation (5) for the data set specific features X^{s} specific to the first data set Ds calculated by the feature calculation unit 15.

$$\begin{matrix}[ Formula 5 ] & \\ {ϕ}^{s} : {x}_{i}^{s} ∈ {R}^{{M}_{s}} ↦ {p}_{i}^{s} ∈ {R}^{M} & ( 5 )\end{matrix}$$

Here, “p^{s}ᵢ” denotes the universal feature calculated from the data set specific feature x^{s}ᵢ of the user i of the first data set Ds, and “M” denotes the dimensions of the feature space of universal features.

Similarly, the universal feature conversion unit 16 performs the process of implementing the mapping “φ^{t}” shown in the following equation (6) for the data set specific features X^{t} specific to the second data set Dt calculated by the feature calculation unit 15.

$$\begin{matrix}[ Formula 6 ] & \\ {ϕ}^{t} : {x}_{j}^{t} ∈ {R}^{{M}_{t}} ↦ {p}_{j}^{t} ∈ {R}^{M} & ( 6 )\end{matrix}$$

Here, “p^{t}ⱼ” denotes the universal feature calculated from the data set specific feature x^{t}ⱼ of the user j of the second data set Dt.

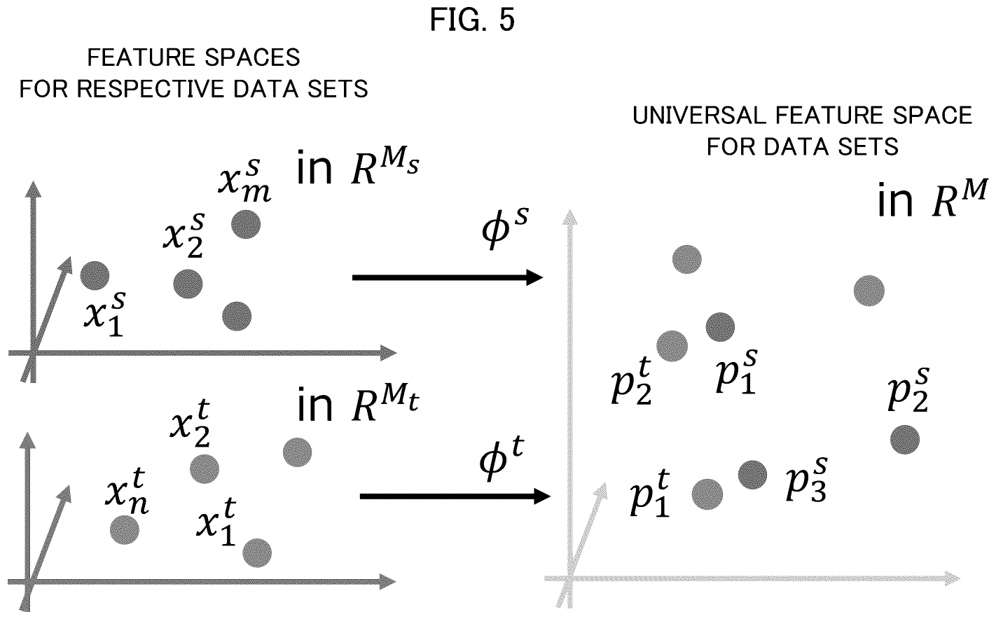

FIG. 5 is a diagram illustrating an overview of the mapping φ^{s} and the mapping φ^{t}. In FIG. 5, the data set specific features (X^{s}={x^{s}₁, x^{s}₂, . . . , x^{s}ₘ}) represented in the feature space of the first data set Ds is converted to the universal features {p^{s}₁, p^{s}₂, p^{s}₃, . . . } by the mapping φ^{s}, and the data set specific features (X^{t}={x^{t}₁, x^{t}₂, . . . , x^{t}ₙ}) represented in the feature space of the second data set Dt is converted to the universal features {p^{t}₁, p^{t}₂, . . . } by the mapping φ^{s}. Here, the universal features {p^{s}₁, p^{s}₂, p^{s}₃, . . . } of the first data set Ds and the universal features {p^{t}₁, p^{t}₂, . . . } of the second data set Dt are all expressed in the common feature space (i.e., the universal feature space of the data set).

Next, a specific calculation method of the universal features will be described. In the following example, optimizing an objective function which includes common user parameters (referred to as “first user parameters”) in common among data sets and dataset-specific user parameters (referred to as “second user parameters”) is performed and thereby the first user parameters are obtained as universal features. The first user parameters correspond to an approximate solution of the first user parameters when the matrix representing the universal features of the first data set Ds and the matrix representing the universal features of the second data set Dt are matrix-decomposed into a form including a block matrix having a block of the first user parameters and a block of the second user parameters.

The universal feature conversion unit 16 performs the matrix decomposition of the matrix representing the data set specific features into the form of “PΣQ^{T}” using a feature matrix “P” regarding users and a feature matrix “Q” regarding items and a matrix “Σ” for adjusting dimensions. Specifically, the universal feature conversion unit 16 performs the matrix decomposition, shown in the following equations (7) and (8), of the data set specific features X^{s} and the data set specific features X^{t}.

$$\begin{matrix}[ Formula 7 ] & \\ {X}^{s} = ( \begin{matrix}{P}_{1}^{s} & {P}_{2}^{s}\end{matrix} ) ( \begin{matrix}{\sum }_{11} & {\sum }_{12}^{s} \\ {\sum }_{21}^{s} & {\sum }_{22}^{s}\end{matrix} ) {( \begin{matrix}{Q}_{1}^{s} & {Q}_{2}^{s}\end{matrix} )}^{T} , & ( 7 )\end{matrix}$$

$${X}^{t} = ( \begin{matrix}{P}_{1}^{t} & {P}_{2}^{t}\end{matrix} ) ( \begin{matrix}{\sum }_{11} & {\sum }_{12}^{t} \\ {\sum }_{21}^{t} & {\sum }_{22}^{t}\end{matrix} ) {( \begin{matrix}{Q}_{1}^{t} & {Q}_{2}^{t}\end{matrix} )}^{T} \qquad ( 8 )$$

Here, the feature matrix P regarding users is represented as a block matrix having blocks (submatrices) “P^{s}₁” and “P^{s}₂” in the equation (7) while the feature matrix P regarding users is represented as a block matrix having blocks “P^{t}₁” and “P^{t}₂” in the equation (8). In addition, the matrix Σ is expressed as a block matrix having blocks (submatrices) “Σ₁₁”, “Σ^{s}₁₂”, “Σ^{s}₂₁”, “Σ^{s}₂₂” in the equation (7), and the matrix Σ is expressed as a block matrix having blocks “Σ₁₁”, “Σ^{t}₁₂”, “Σ^{t}₂₁”, “Σ^{t}₂₂” in the equation (8). The feature matrix Q regarding items is expressed as a block matrix having blocks (submatrices) “Q^{s}₁” and “Q^{s}₂” in the equation (7) while it is expressed as a block matrix having blocks “Q^{t}₁” and “Q^{t}₂” in the equation (8).

In this case, in the equation (7) and the equation (8), the submatrices P^{s}₁ and P^{t}₁ in the feature matrix regarding users are to be multiplied by the common submatrix Σ₁₁ of the matrix Σ and are matrices having, as their elements, the first user parameters that are universal in the data sets. The size (the number of rows and columns) of the submatrix Σ₁₁ is, for example, set to a fit value previously stored in the memory 12 or the like. On the other hand, the submatrices P^{s}₂ and P^{t}₂ of the feature matrix regarding users are to be multiplied by the submatrices (Σ^{s}₂₁, Σ^{s}₂₂, Σ^{t}₂₁, Σ^{t}₂₂) of the matrix Σ which are specific to each data set and are matrices having, as their elements, the second user parameters that are dataset-specific.

Accordingly, in this instance, the mapping φ^{s} is represented as a mapping that converts the data set specific feature x^{s}ᵢ of the user i specific to the first data set Ds to the first user parameters P^{s}₁, as shown in the following equation (9). Similarly, the mapping φ^{t} is represented as a mapping that converts the data set specific feature x^{t}ⱼ of the user j of the second data set Dt to the first user parameters P^{t}₁, as shown in the following equation (10).

$$\begin{matrix}[ Formula 8 ] & \\ {ϕ}^{s} ( {x}_{i}^{s} ) = {ϕ}^{s} ( {X}^{s} [ i ] ) = {P}_{1}^{s} [ i ] & ( 9 )\end{matrix}$$

$${ϕ}^{t} ( {x}_{j}^{t} ) = ϕ ( {X}^{t} [ j ] ) = {P}_{1}^{t} [ j ] \qquad ( 10 )$$

Therefore, the universal features conversion unit 16 calculates, as the universal features, the first user parameters P^{s}₁ and P^{t}₁ obtained by performing the matrix decomposition of the data set specific features X^{s} specific to the first data set Ds and the data set specific features X^{t} specific to the second data set Dt in the format shown in the equations (7) and (8). Here, as an example, the universal feature conversion unit 16 sets the objective function to be the minimum when the expression (7) and the expression (8) are satisfied, and solves the optimization problem of minimizing the objective function. Specifically, the universal feature conversion unit 16 solves the optimization problem according to the following equation (11).

$$\begin{matrix}[ Formula 9 ] & \\ arg min ( ‖ {X}^{s} - ( \begin{matrix}{P}_{1}^{s} & {P}_{2}^{s}\end{matrix} ) ( \begin{matrix}{\sum }_{11} & {\sum }_{12}^{s} \\ {\sum }_{21}^{s} & {\sum }_{22}^{s}\end{matrix} ) {( \begin{matrix}{Q}_{1}^{s} & {Q}_{2}^{s}\end{matrix} )}^{T} ‖ + ‖ {X}^{t} - ( \begin{matrix}{P}_{1}^{t} & {P}_{2}^{t}\end{matrix} ) ( \begin{matrix}{\sum }_{11} & {\sum }_{12}^{t} \\ {\sum }_{21}^{t} & {\sum }_{22}^{t}\end{matrix} ) {( \begin{matrix}{Q}_{1}^{t} & {Q}_{2}^{t}\end{matrix} )}^{T} ‖ ) & ( 11 )\end{matrix}$$

According to the equation (11), the universal features conversion unit 16 calculates first user parameters (i.e., P^{s}₁ and P^{t}₁) so as to minimize the objective function which is the sum of the norm of the difference between the right side and the left side of the equation (7) and the norm of the difference between the right side and the left side of the equation (8). Thereby, the universal feature conversion unit 16 can suitably calculate the universal features of the first data set Ds and the universal features of the second data set Dt.

Although the universal features conversion unit 16 obtained the first user parameters P^{s}₁ and P^{t}₁ in the equation (7) and the equation (8) by the optimization shown in the equation (11), the method of calculating the first user parameters P^{s}₁ and P^{t}₁ is not limited thereto. Alternatively, the universal feature conversion unit 16 may obtain the first user parameters P^{s}₁ and P^{t}₁ by calculating the approximate solution of the matrix decomposition shown in the equations (7) and (8) using any approximate solution such as the gradient method. Even in this case, the universal features conversion unit 16 can suitably determine the first user parameters P^{s}₁ and P^{t}₁ that are the universal features. Generally, it is possible to regard the optimization problem of matrix decomposition in any form as a neural network and solve the optimal value of the matrix decomposition by using any deep learning library such as PyTorch. Therefore, the universal feature conversion unit 16 may acquire the first user parameters P^{s}₁ and P^{t}₁ that are the universal features by obtaining the solution of the matrix decomposition shown in the equations (7) and (8) using an arbitrary deep learning library.

Next, a description will be given of such a case that apart of a combination between users of the first data set Ds and users of the second data set Dt that are related users is already known in advance. In this case, the universal feature conversion unit 16 provides, in the objective function shown in the equation (11), a term that becomes the minimum value of 0 at the time when the first user parameters (i.e., the universal features) of users, who are already found to be related users by prior knowledge, are identical. Specifically, when “P^{s}₁ [tr]” denotes the matrix representing the first user parameters of a user, who is already found to be a related user, of the first data set Ds and “P^{t}₁ [tr]” denotes the matrix representing the universal features of the corresponding related user of the second data set Dt, the universal feature conversion unit 16 solves the optimization problem according to the following equation (12).

$$\begin{matrix}[ Formula 10 ] & \\ arg min = ( \begin{matrix}‖ {X}^{s} - ( \begin{matrix}{P}_{1}^{s} & {P}_{2}^{s}\end{matrix} ) ( \begin{matrix}{\sum }_{11} & {\sum }_{12}^{s} \\ {\sum }_{21}^{s} & {\sum }_{22}^{s}\end{matrix} ) {( \begin{matrix}{Q}_{1}^{s} & {Q}_{2}^{s}\end{matrix} )}^{T} ‖ + \\ ‖ {X}^{t} - ( \begin{matrix}{P}_{1}^{t} & {P}_{2}^{t}\end{matrix} ) ( \begin{matrix}{\sum }_{11} & {\sum }_{12}^{t} \\ {\sum }_{21}^{t} & {\sum }_{22}^{t}\end{matrix} ) {( \begin{matrix}{Q}_{1}^{t} & {Q}_{2}^{t}\end{matrix} )}^{T} ‖ + \\ λ ‖ {P}_{1}^{s} [ tr ] - {P}_{1}^{t} [ tr ] ‖\end{matrix} ) & ( 12 )\end{matrix}$$

Where “λ” is the regularization parameter and is set to “λ>0”. By setting the objective function as shown in the equation (12), it is possible to suitably utilize the prior knowledge about a set of already-known related users to thereby accurately calculate the first user parameters P^{s}₁ and P^{t}₁.

In addition, the universal feature conversion unit 16 may provide, in the objective function, a term for obtaining such first user parameters (i.e., the universal features) that pseudo linkage between similar users is allowed, wherein the similar users are the user u′(∈U^{tr}) who is already known to be a related user by prior knowledge and the user u′(∈U^{s}) of the first data set Ds similar to the user u in the first data set Ds. Specifically, when “S^{s}_{uu′}” denotes the degree of similarity between the user u and the user u′ in the first data set Ds i and “P^{s}₁ [u′]” denotes the first user parameters of the user having the degree of similarity S^{s}_{uu′} to the user u in the first data set Ds who is found to be a related user and “P^{t}₁ [u]” denotes the universal feature of the user u of the second data set Dt, the universal feature conversion unit 16 solves the optimization problem according to the following equation (13).

$$\begin{matrix}[ Formula 11 ] & \\ arg min = ( \begin{matrix}‖ {X}^{s} - ( \begin{matrix}{P}_{1}^{s} & {P}_{2}^{s}\end{matrix} ) ( \begin{matrix}{\sum }_{11} & {\sum }_{12}^{s} \\ {\sum }_{21}^{s} & {\sum }_{22}^{s}\end{matrix} ) {( \begin{matrix}{Q}_{1}^{s} & {Q}_{2}^{s}\end{matrix} )}^{T} ‖ + \\ ‖ {X}^{t} - ( \begin{matrix}{P}_{1}^{t} & {P}_{2}^{t}\end{matrix} ) ( \begin{matrix}{\sum }_{11} & {\sum }_{12}^{t} \\ {\sum }_{21}^{t} & {\sum }_{22}^{t}\end{matrix} ) {( \begin{matrix}{Q}_{1}^{t} & {Q}_{2}^{t}\end{matrix} )}^{T} ‖ + \\ λ {\sum }_{u ∈ {U}^{tr}} {\sum }_{{u}^{′} ∈ {U}^{s}} {S}_{{uu}^{′}}^{s} ‖ {P}_{1}^{s} [ {u}^{′} ] - {P}_{1}^{t} [ u ] ‖\end{matrix} ) & ( 13 )\end{matrix}$$

Where “λ” is a regularization parameter and is set to “λ>0”. “S^{s}_{uu′}” denotes the degree of similarity between the user u and the user u′ in the first data set Ds, and it is easy to calculate the degree of similarity in the same data set. By setting the objective function as shown in the equation (13), the prior knowledge about the set of already-known related users and users similar to the related users can be suitably utilized, and the first user parameters P^{s}₁ and P^{t}₁ can be accurately calculated.

### (3-4) Processing by Similarity Degree Calculation Unit

The similarity degree calculation unit 17 calculates the degree of similarity of the pair of universal features (p^{s}ᵢ, p^{t}ⱼ) for all combinations between the users of the first data set Ds and the users of the second data set Dt. In this instance, the similarity degree calculation unit 17 performs a process of implementing the following mapping “sim”.

$$\begin{matrix}[ Formula 12 ] & \\ sim : ( {p}_{i}^{s} , {p}_{j}^{t} ) ∈ {R}^{M} \times {R}^{M} ↦ s i m ( {p}_{i}^{s} , {p}_{j}^{t} ) ∈ R & \end{matrix}$$

For example, the similarity degree calculation unit 17 calculates the degree of similarity of the pair of the universal features (p^{s}ᵢ, p^{t}ⱼ) by using the cosine similarity (<p^{s}ᵢ, p^{t}ⱼ>/|p^{s}ᵢ∥p^{t}ⱼ|). In another example, the similarity degree calculation unit 17 calculates the degree of similarity of the pair of the universal features (p^{s}ᵢ, p^{t}ⱼ) by using the Gaussian similarity (exp (−α|p^{s}ᵢ−p^{t}ⱼ|²) (α>0)). In still another example, as illustrated below, the similarity degree calculation unit 17 calculates the degree of similarity of the pair of the universal feature (p^{s}ᵢ, p^{t}ⱼ) based on the degree of similarity determined from the distance “d (p^{s}ᵢ, p^{t}ⱼ)” between the pair of the universal feature (p^{s}ᵢ, p^{t}ⱼ).

$$sim ( {p}_{i}^{s} , {p}_{j}^{t} ) = 1 - d ( {p}_{i}^{s} , {p}_{j}^{t} )$$

$$sim ( {p}_{i}^{s} , {p}_{j}^{t} ) = {\{ 1 + d ( {p}_{i}^{s} , {p}_{j}^{t} ) \}}^{- 1}$$

It is noted that the distance d (p^{s}ᵢ, p^{t}ⱼ) may be L² distance or the Jensen-Shannon divergence. Further, the similarity degree calculation unit 17 may calculate one degree of similarity obtained by aggregating the calculation results of a plurality of degrees of similarity calculated by any above-described methods using an aggregation function such as an arithmetic mean, a geometric mean, a harmonic mean, a cross ratio uninorm.

(3-5) Processing by Related user Identification Unit

Next, identification and linkage of the related users by the related user identification unit 18 will be described. The related user identification unit 18 performs a process of implementing the following mapping “Sync”.

$$\begin{matrix}[ Formula 13 ] & \\ Sync : i ∈ {U}^{s} ↦ \{ {j}_{1} , … {j}_{k} \} ⊂ {U}^{t} & \end{matrix}$$

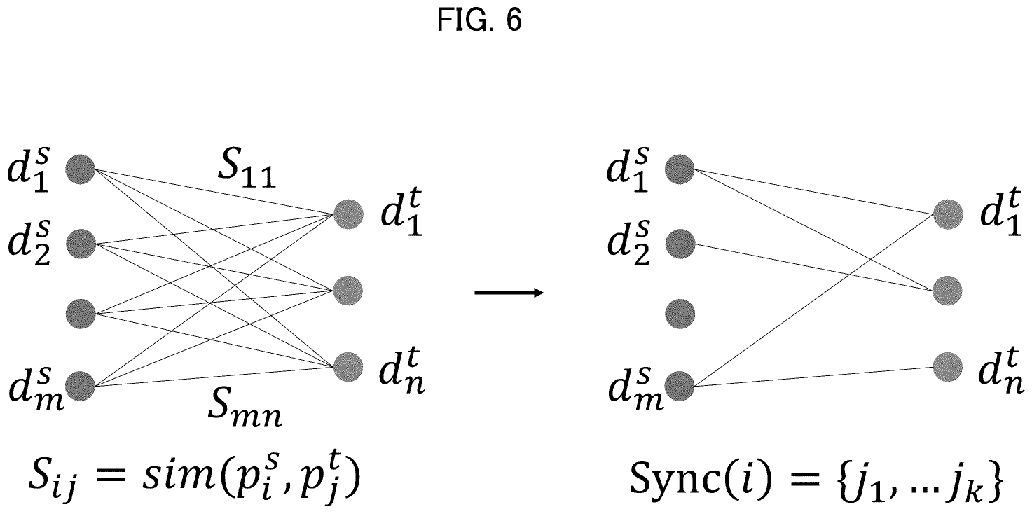

FIG. 6 is a diagram showing an outline of a mapping sim and a mapping Sync. In FIG. 6, first, the degree of similarity “Sᵢⱼ” (=sim (p^{s}ᵢ, p^{t}ⱼ)) of the universal features for all combinations between each data {d^{s}₁, d^{s}₂, . . . , d^{s}ₘ} of the first data set Ds and each data {d^{t}₁, . . . , d^{t}₁} of the second data set Dt is calculated. The related user identification unit 18 identifies the users {j₁, . . . , jₖ} related to the user i of the first data set Ds based on the degree of similarity Sᵢⱼ for all combinations between the data {d^{s}₁, d^{s}₂, . . . , d^{s}ₘ} of the first data set Ds and the data {d^{t}₁, . . . , d^{t}ₙ} of the second data set Dt. In the right figure in FIG. 6, data corresponding to a pair of users identified as a related user are connected by line. Here, the correspondence between the user of the first data set Ds and the user of the second data set Dt is not limited to one-to-one, and may be plural-to-one correspondence or one-to-plural correspondence. There may also be users that are not linked with any user.

Next, a specific example of a method of identifying the related users will be described. For example, the related user identification unit 18 determines that the user of the second data set Dt having the largest degree of similarity to user i (∈U^{s}) of the first data set Ds is the related user. In this instance, one user of the second data set Dt is identified as the related user for each user of the first data set Ds. In another example, the related user identification unit 18 determines that the user of the second data set Dt whose degree of similarity to user i (∈U^{s}) of the first data set Ds is equal to or greater than a predetermined threshold is the related user. In this instance, no related user may be identified for a user of the first data set Ds, or multiple users may be identified as related users. In yet another example, the related user identification unit 18 identifies, as the related users, users of the second data set Dt having one or more top degrees of similarity to each user of the first data set Ds. In yet another example, the related user identification unit 18 may identify one or more users of the second data set Dt to be linked with each user of the first data set Ds based on a matching algorithm for the bipartite graph, such as a Gale-Shapley algorithm.

The related user identification unit 18 may identify the related user from the above-described degree of similarity based on a probabilistic approach. When “μᵤ” denotes the distribution of the users of the second data set Dt identified as the related users, the mapping Sync is expressed by the following equation.

$$\begin{matrix}[ Formula 14 ] & \\ Sync ( i ) = \{ j \vert j is sampled from {μ}_{u} \} & \end{matrix}$$

Here, the distribution μᵤ may be a uniform distribution, or it may be a distribution corresponding to the degree of similarity. For example, when using soft-max, the distribution μᵤ depending on the degree of similarity is expressed by the following equation.

$$\begin{matrix}[ Formula 15 ] & \\ {μ}_{u} ( j is sampled ) = exp ( {S}_{i j} ) / {\sum }_{j ∈ {U}^{t}} exp ( {S}_{i j} ) & \end{matrix}$$

In this case, for example, if there a user B of the second data set Dt which is “0.9” based on the above-described expression for a user A of the first data set Ds, the related user identification unit 18 identifies the user A and the user B as related users with a 90% probability. On the other hand, if there is a user C of the second data set Dt which becomes “0.1” for the user A of the first data set Ds based on the above-described equation, the related user identification unit 18 identifies the user A and the user C as related users with a 10% probability. As such, the related user identification unit 18 may identify the user of the first data set Ds and the user of the second data set Dt as the related user according to the probability corresponding to the degree of similarity between these users.

According to the above-described examples, the related user identification unit 18 suitably identifies the related users based on the degree of similarity calculated by the similarity degree calculation unit 17 and suitably generates the related user information Iu which links these users.

### (4) Concrete Examples

Next, specific examples of the user linkage process described above will be described with reference to the drawings.

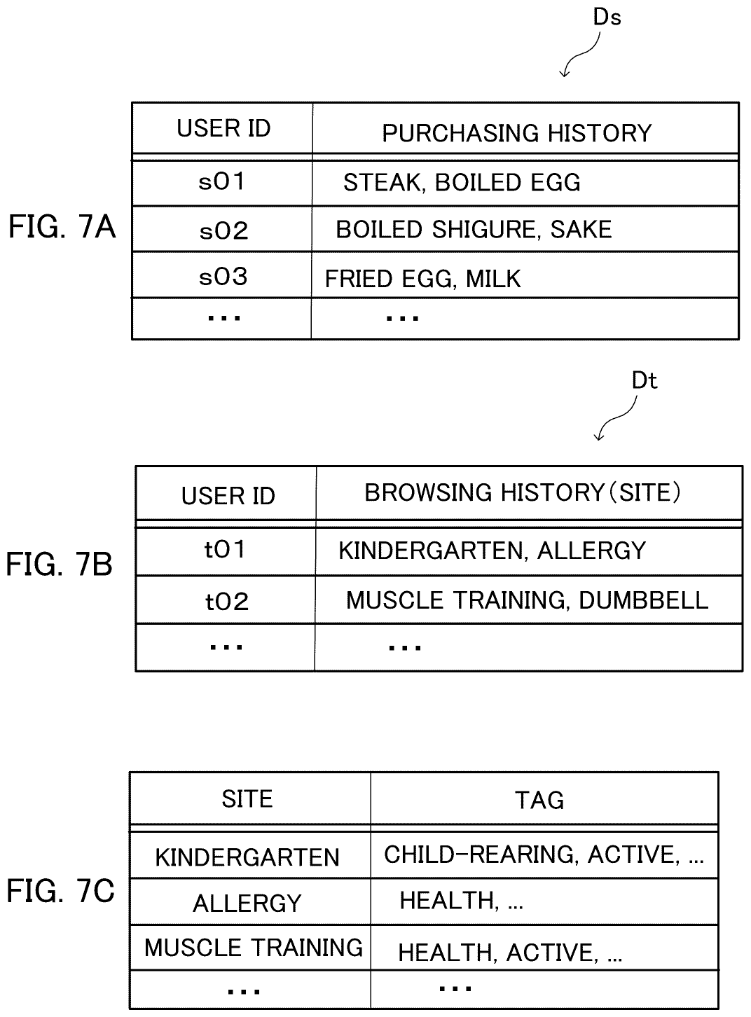

FIG. 7A illustrates an example of the data structure of the first data set Ds representing the purchasing history in a certain supermarket, and FIG. 7B illustrates an example of the data structure of the second data set Dt representing the browsing history in the internet. FIG. 7C illustrates an example of table information representing tags associated with each site (including website and advertisement).

Hereinafter, “d^{s}ᵢ=(a^{s}₁, . . . , a^{s}ₘ)∈D^{s}” denotes the history of purchases by user i, and “a^{s}₁” denotes a product sold in the supermarket. In addition, “d^{t}ᵢ=(a^{t}₁, . . . , a^{t}ₘ)∈D^{t}” denotes the browsing history data of user j, and “a^{t}₁” denotes a website that can be browsed on the Internet. As shown in FIG. 7C, each site is associated with one or more tags.

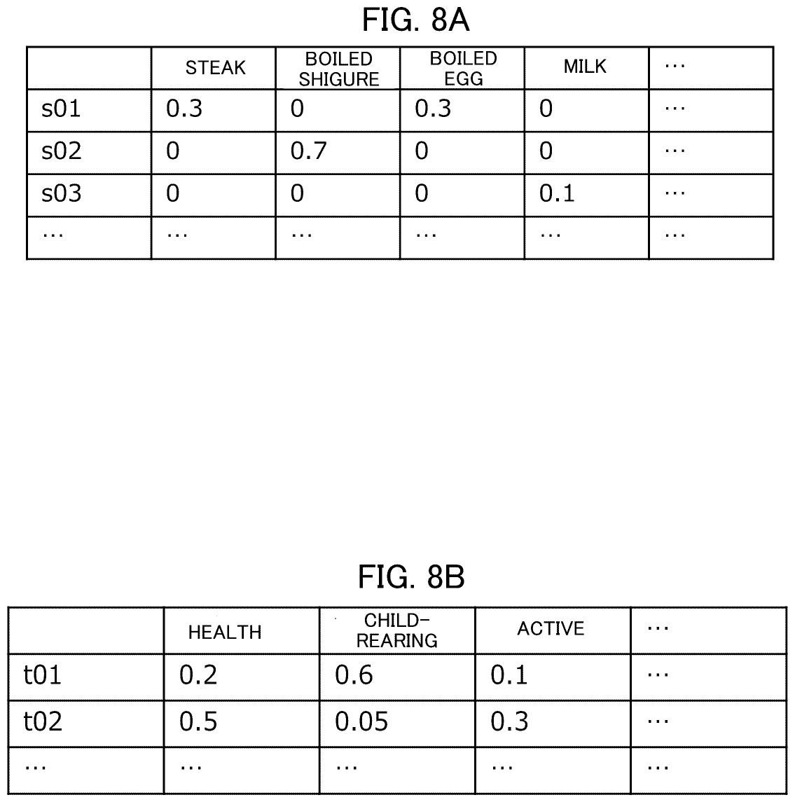

FIG. 8A illustrates an example of the data set specific features calculated from the first data set Ds shown in FIG. 7A, and FIG. 8B illustrates an example of the data set specific features calculated from the second data set Dt shown in FIG. 7B and the table information shown in FIG. 7C.

In the example shown in FIG. 8A, the feature calculation unit 15 calculates the data set specific feature x^{s}ᵢ (∈R^{Ms}) for each user i by applying a TF-IDF that is an example of the mapping h^{s} shown in the equation (1) to the purchase history data d^{s}ᵢ for each user i of the first data set Ds shown in FIG. 7A. The entire table shown in FIG. 8A corresponds to the data set specific features X^{s} (see the equation (2)).

In the example shown in FIG. 8B, the feature calculation unit 15 calculates the data set specific feature x^{t}ⱼ (∈R^{Mt}) for each user j by applying a TF-IDF that is an example of the mapping h^{t} shown in the equation (3) to the set of tags corresponding to the browsing history data d^{t}ⱼ of each user j of the second data set Dt shown in FIG. 7B. The entire table shown in FIG. 8B corresponds to the data set specific feature matrix X^{t} (see the equation (4)).

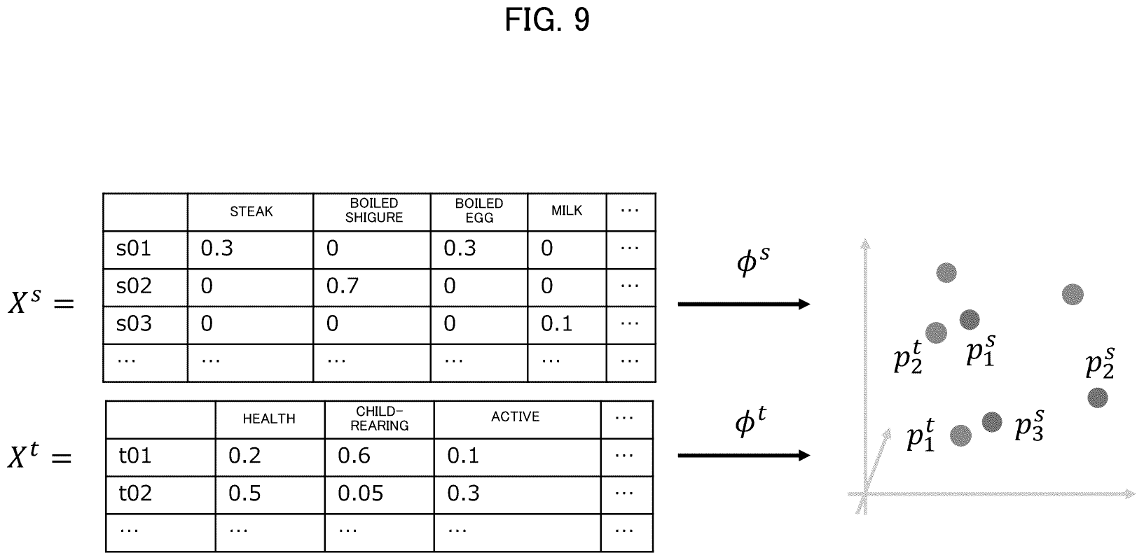

FIG. 9 is a diagram illustrating an outline of the process of converting the data set specific features X^{s} corresponding to the table shown in FIG. 8A and the data set specific features X^{t} corresponding to the table shown in FIG. 8B to the universal features. In FIG. 9, the universal feature conversion unit 16 converts the data set specific features X^{s} corresponding to the table shown in FIG. 8A into the universal feature p^{s}ᵢ (p^{s}₁, p^{s}₂, p^{s}₃, . . . ,) using the mapping φ^{s} shown in the equation (5). The universal feature conversion unit 16 converts the data set specific features X^{t} corresponding to the table shown in FIG. 8B to the universal feature p^{t}ᵢ (p^{t}₁, p^{t}₂, p^{t}₃, . . . ) using the mapping φ^{t} shown in the equation (6). In this case, for example, the universal feature conversion unit 16 regards the data set specific features X^{s} corresponding to the table shown in FIG. 8A and the data set specific features X^{t} corresponding to the table shown in FIG. 8B as matrices, respectively, and solves the optimization problem shown in the equation (11) for matrix decomposition of these matrices to thereby calculate the above-described universal features p^{s}ᵢ and p^{t}ᵢ.

Thereafter, for example, the similarity degree calculation unit 17 calculates the degree of similarity for all combinations between the user i of the first data set Ds and the user j of the second data set Dt using the cosine similarity or the like, and the related user identification unit 18 identifies any combination of users whose degree of similarity is equal to or greater than a threshold value (for example, 0.95) as the related user(s).

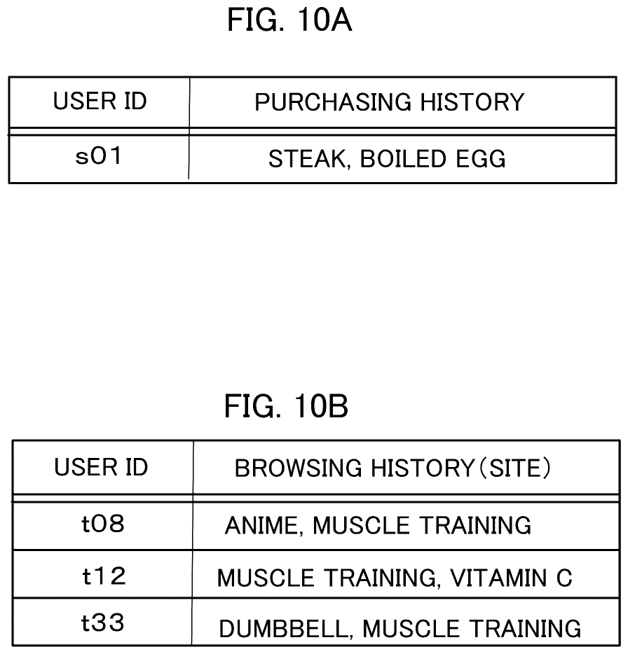

FIG. 10A and FIG. 10B show a combination of data of the users identified as a related user by the related user identification unit 18. FIG. 10A shows the purchase history data of the user ID “s01”, and FIG. 10B shows the browsing history data of the user ID “t08”, “t12”, and “t33”. Here, the related user identification unit 18 identifies, as the related users, users of the user ID “t08”, “t12” and “t33” of the second data set Dt having the universal features whose degree of similarity to the universal feature of the user ID “s01” is equal to or greater than a threshold value (in this case, 0.95). Therefore, the related user identification unit 18 generates the related user information Iu which links the user ID “s01” with the user ID “t08”, “t12”, and “t33”.

As described above, in this example embodiment, the information processing device 1 can accurately identify the related users between the data set of the supermarket and the data set of the browsing history of the internet and generate the related user information Iu. Then, by performing user linkage between purchase history and web-browsing history, it can be used for recommendation accuracy improvement and marketing measures.

The combination of data sets subject to user linkage is not limited to the combination according to the specific example. For example, if the same or similar types of data sets between the own company and a competitor are targeted, it can be suitably used for competitive analysis. Further, when the data set regarding an advertising distribution and the data set regarding an advertising provider are targeted, it can be suitably used for the measurement of the effect of the advertisement.

### (5) Processing Flow

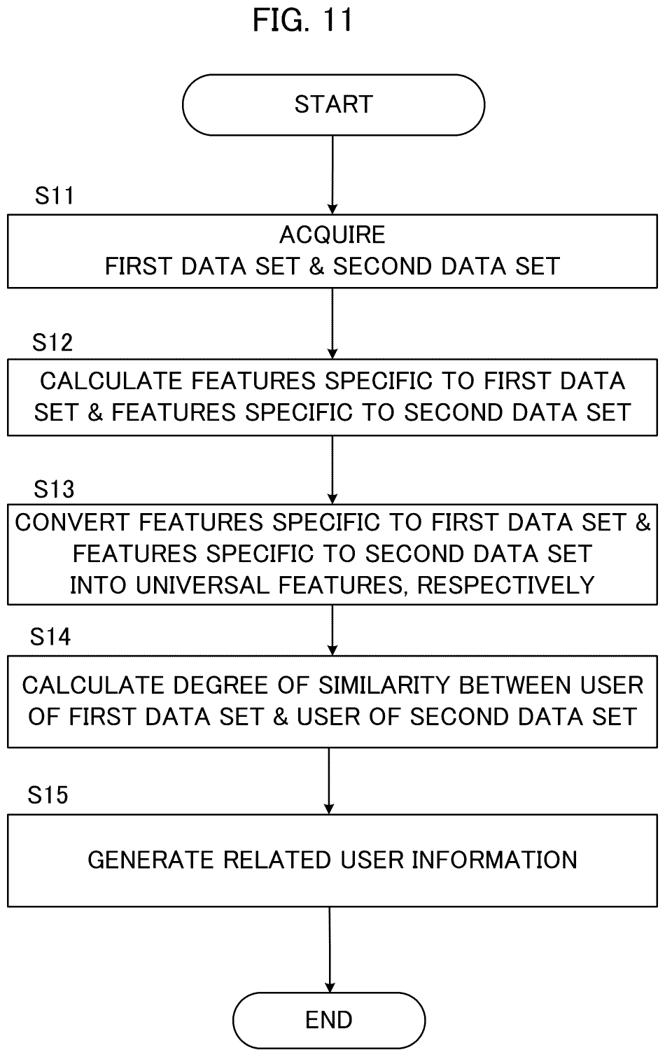

FIG. 11 is an example of a flowchart illustrating a procedure of a user linkage process performed by the information processing device 1.

First, the feature calculation unit 15 of the information processing device 1 acquires the first data set Ds and the second data set Dt from the storage device 2 via the interface 13 (step S11). Then, the feature calculation unit 15 calculates the data set specific features specific to the first data set Ds, and the data set specific features specific to the second data set Dt, respectively (step S12). In this case, the feature calculation unit 15 performs the process of implementing the mapping h^{s} shown in the equation (1) with respect to the first data set Ds, and performs the process of implementing the mapping h^{t} shown in the equation (3) with respect to the second data set Dt.

Next, the universal feature conversion unit 16 converts the data set specific features specific to the first data set Ds and the data set specific features specific to the second data set Dt into universal features, respectively (step S13). In this case, the universal feature conversion unit 16 performs the process of implementing the mapping φ^{s} shown in the equation (5) for the data set specific features of the first data set Ds, and performs the process of implementing the mapping φ^{t} shown in the equation (6) for the data set specific features of the second data set Dt.

Next, the similarity degree calculation unit 17 calculates the degree of similarity between the user of the first data set Ds and the user of the second data set Dt (step S14). In this case, for every combination of the user of the first data set Ds and the user of the second data set Dt, the similarity degree calculation unit 17 calculates the degree of similarity based on the corresponding universal features.

Then, the related user identification unit 18 generates the related user data Iu based on the degree of similarity calculated at step S14 (step S15). In this instance, the related user identification unit 18 identifies the user(s) of the second data set Dt related to each user of the first data set Ds on the basis of the degree of similarity calculated at step S14, and generates the related user information Iu representing the identified results.

As described above, according to the present example embodiment, the information processing device 1 can suitably execute the user linkage among the data sets in which the user ID is separately managed. In this case, the information processing device 1 can automatically execute the user linkage of the data sets with large amount of complicated data which cannot be handled manually. Further, even when personal information such as a name of a user, a demographic attribute, and a Cookie are not available under various restrictions, the information processing device 1 can suitably execute user linkage among data sets without requiring such information.

### Second Example Embodiment

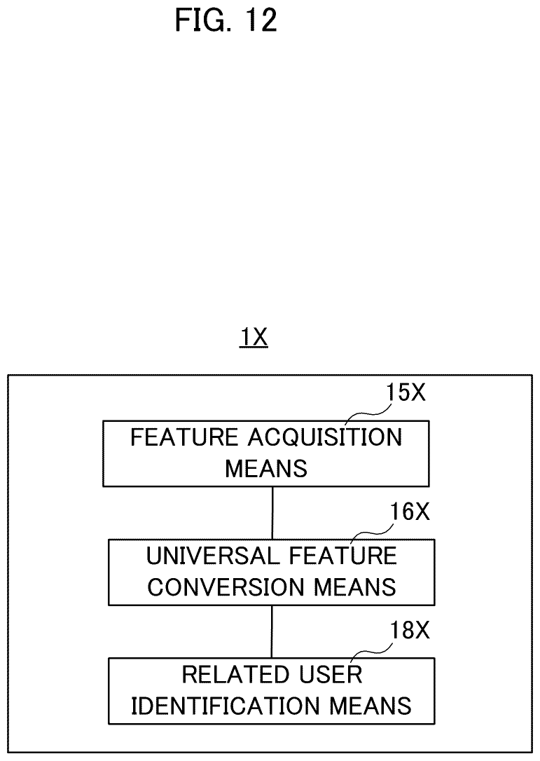

FIG. 12 is a block diagram illustrating an information processing device 1X according to the second example embodiment. As shown in FIG. 12, the information processing device 1X mainly include a feature acquisition means 15X, a universal feature conversion means 16X, and a related user identification means 18X. The information processing device 1X may be configured by a plurality of devices.

The feature acquisition means 15X is configured to acquire first data set specific features, which are user's features specific to a first data set and second data set specific features, which are user's features specific to a second data set. In this instance, the feature acquisition means 15X may calculate the first and second data set specific features from the first and second data sets, respectively, or may acquire (receive) the first and second data set specific features calculated in advance for each data set from a memory or an external device. Examples of the feature acquisition means 15X in the former case include the feature calculation unit 15 in the first example embodiment.

The universal feature conversion means 16X is configured to convert the first data set specific features and the second data set specific features into universal features which are features in a universal feature space for the first data set and the second data set, respectively. Examples of the universal feature conversion means 16X include the universal feature conversion unit 16 in the first example embodiment.

The related user identification means 18X is configured to identify a user related to the first data set and the second data set based on the universal features of the first data set and the universal features of the second data set. Examples of the related user identification means 18X include the similarity degree calculation unit 17 and the related user identification unit 18.

For example, the related user identification means 18X may identify the user related to the first data set and the second data set by using an inference engine configured to output a combination of users inferred to be related to each other between the data sets when universal features of the first data set with respect to each user and universal features of the second data set with respect to each user are inputted to the inference engine. In this instance, the related user identification means 18X is configured to perform the above-described user identification by configuring the above-described inference engine by referring to a memory or the like which stores parameters of the above-described inference engine trained in advance based on machine learning or the like.

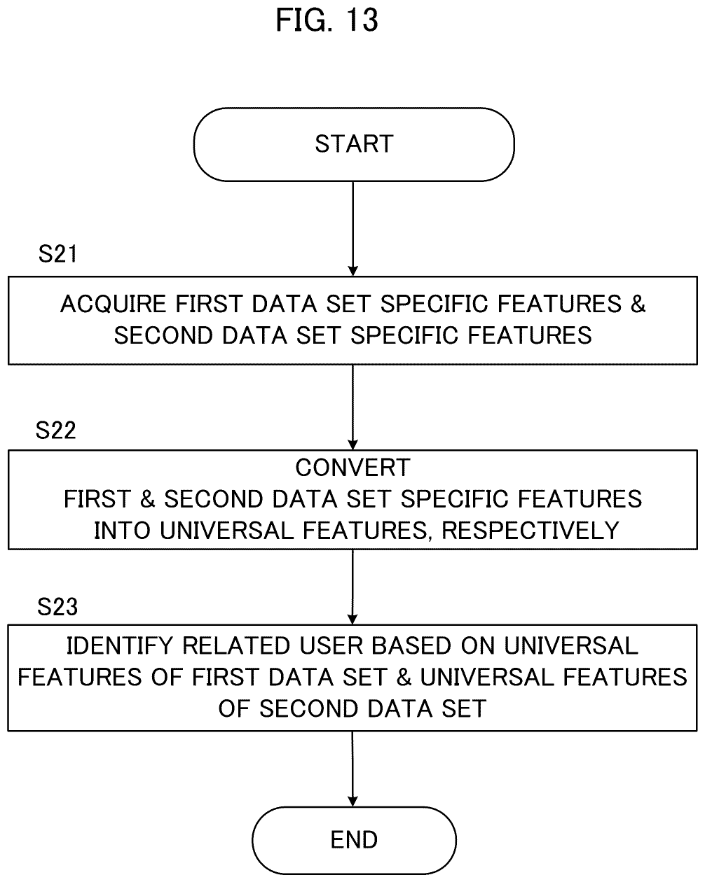

FIG. 13 is an example of a flowchart to be executed by the information processing device 1X in the second example embodiment. First, the feature acquisition means 15X acquires first data set specific features, which are user's features specific to a first data set and second data set specific features, which are user's features specific to a second data set (step S21). The universal feature conversion means 16X converts the first data set specific features and the second data set specific features into universal features which are features in a universal feature space for the first data set and the second data set, respectively (step S22). The related user identification means 18X identifies a user related to the first data set and the second data set based on the universal features of the first data set and the universal features of the second data set (step S23).

According to the second example embodiment, the information processing device 1X can suitably identify a user related among different data sets without requiring personal data or the like.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1X Information processing device
2 Storage device
11 Processor
12 Memory
13 Interface
100 User linkage system

What is claimed is:

1. An information processing device comprising:
at least one memory configured to store instructions; and
at least one processor configured to execute the instructions to:
acquire
first data set specific features of users being specific to a first data set and
second data set specific features of users being specific to a second data set;
convert each of the first data set specific features and the second data set specific features into universal features, being in a universal feature space for the first data set and the second data set; and
identify a user related to the first data set and the second data set based on the universal features of the first data set and the universal features of the second data set.

2. The information processing device according to claim 1,
wherein the at least one processor is configured to execute the instructions to perform matrix decompositions of
a matrix representing the first data set specific features and
a matrix representing the second data set specific features
into a form which includes a matrix representing first user parameters and a matrix representing second user parameters, thereby to calculate and acquire the first user parameters as the universal features,
the first user parameters indicating user's parameters universal for the first data set and the second data set,
the second user parameters indicating user's parameter specific to the first data set or the second data set.

3. The information processing device according to claim 2,
wherein the at least one processor is configured to execute the instructions to calculate, as the universal features, the first user parameters acquired through optimization of an objective function including the first user parameters and the second user parameters.

4. The information processing device according to claim 3,
wherein, when P^{s}₁ denotes the first user parameters of the first data set, P^{s}₂ denotes the second user parameters of the first data set, P^{t}₁ denotes the first user parameters of the second data set, and P^{t}₂ denotes the second user parameters of the second data set,
the at least one processor is configured to execute the instructions to perform the optimization to minimize the objective function that is minimized when a following equation which indicates the matrix decompositions of the matrix X^{s} representing the first data set specific features and the matrix X^{t} representing the second data set specific features,
$$\begin{matrix}[ Formula 16 ] & \\ {X}^{s} = ( \begin{matrix}{P}_{1}^{s} & {P}_{2}^{s}\end{matrix} ) ( \begin{matrix}{\sum }_{11} & {\sum }_{12}^{s} \\ {\sum }_{21}^{s} & {\sum }_{22}^{s}\end{matrix} ) {( \begin{matrix}{Q}_{1}^{s} & {Q}_{2}^{s}\end{matrix} )}^{T} , \\ {X}^{t} = ( \begin{matrix}{P}_{1}^{t} & {P}_{2}^{t}\end{matrix} ) ( \begin{matrix}{\sum }_{11} & {\sum }_{12}^{t} \\ {\sum }_{21}^{t} & {\sum }_{22}^{t}\end{matrix} ) {( \begin{matrix}{Q}_{1}^{t} & {Q}_{2}^{t}\end{matrix} )}^{T} & \end{matrix}$$

5. The information processing device according to claim 1,
wherein the at least one processor is configured to execute the instructions to calculate the universal features acquired by converting each of the first data set specific features and the second data set specific features into a common feature space.

6. The information processing device according to claim 1,
wherein the first data set and the second data set do not include attribute information regarding the user in common.

7. The information processing device according to claim 1,
wherein the at least one processor is configured to further execute the instructions to calculate a degree of similarity between a user of the first data set and a user of second data set,
wherein the at least one processor is configured to execute the instructions to identify the users related to the first data set and the second data set based on the degree of similarity.

8. The information processing device according to claim 7,
wherein the at least one processor is configured to execute the instructions to identify a user of the first data set and a user of the second data set as the related users with a probability according to the degree of similarity between the user of the first data set and the user of the second data set.

9. A control method executed by a computer, the control method comprising:
acquiring
first data set specific features of users being specific to a first data set and
second data set specific features of users being specific to a second data set;
converting each of the first data set specific features and the second data set specific features into universal features, being in a universal feature space for the first data set and the second data set; and
identifying a user related to the first data set and the second data set based on the universal features of the first data set and the universal features of the second data set.

10. A non-transitory computer readable storage medium storing a program executed by a computer, the program causing the computer to:
acquire
first data set specific features of users being specific to a first data set and
second data set specific features of users being specific to a second data set;
convert each of the first data set specific features and the second data set specific features into universal features, being in a universal feature space for the first data set and the second data set; and
identify a user related to the first data set and the second data set based on the universal features of the first data set and the universal features of the second data set.
